(19) United States
(12) Patent Application Publication
(10) Pub. No.: US 2006/0063546 A1
(43) Pub. Date: Mar. 23, 2006

(54) Method of increasing the data transmission rate in a mobile radio system

(75) Inventor: Harald Fischer, Bad Ems (DE)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/523,939

(22) PCT Filed: Aug. 5, 2003
(86) PCT No.: PCT/IB03/03141

§ 371 Date: Feb. 8, 2005

(30) Foreign Application Priority Data
Aug. 10, 2002 (EP) 02017968.5

(51) Int. Cl. H04B 7/00

(52) U.S. Cl. 455/517

(57) ABSTRACT

The invention relates to a method of increasing the data transmission rates in a mobile radio system, as well as a computer program for executing the method according to the invention. The invention protects a mobile radio system, a mobile station (MS) and a base station (BS), which are suitable for use with the method according to the invention. The method itself arranges for the problem setting on which the invention is based to provide a possibility which allows the data transmission rate between a base station (BS) and a mobile station (MS) in a mobile radio system to increase in that the data to be transmitted are transmitted packet by packet in combined form with an address coding value over at least two frequency channels.

The present invention relates to a method of increasing the data transmission rate between a base station and a mobile station in a mobile radio system. Furthermore, the invention relates to a mobile radio system that executes the method according to the invention. In addition, the invention pertains to a base station as well as a mobile station which, on their side make the increase possible of the data transmission rates in a mobile radio system while implementing the inventive method. Furthermore, the invention relates to a computer program for executing the method according to the invention in a mobile radio system.

In the field of mobile radio the GSM system has meanwhile been used virtually worldwide as a standard for digital cellular mobile radio systems. This standard makes along with just speech and data communication a great number of other service features possible such as Short Message Services (SMS), CLID, Forwarding-etc., so that the performance capacity of the mobile radio network reaches the ISDN performance of the fixed network. Besides, national and international roaming is possible in such a system.

GSM networks work in various frequency channels. The most widely used is the 900 MHz band which is used in Germany in essence by D1 and D2 Vodafon. In the range of 1800 MHz, E-Plus and meanwhile also Viag-Intercom radio in Germany. Since the 900 Mhz band has meanwhile come to its limit capacity and nearly all current mobile telephones in Germany are dual band mobile phones, thus can send and receive either in the 900 MHz band or in the 1800 MHz band, meanwhile D1 and D2-Vodafon also have the possibility to radio in the 1800 MHz band. The worldwide use of GSM mobile phones conflicts with the fact that in North America radio is operated in the 1900 MHz band. Meanwhile, however, so-called triband mobile phones have appeared on the market with which alternatively can be radioed in one of the three frequency channels. In principle, however, it is always possible to send or receive on one of the respective frequency channels. It is possible indeed by national or international roaming to change the network user and thus the send and receive frequency, however, one is always confined to one frequency channel.

According to the GSM standard, each frequency channel has 124 channels which are again subdivided into eight time slots of 577 μs each, in which 156.25 data bits each can be transmitted. Eight of these time slots together form a so-called TDMA frame. One TDMA frame thus has eight time slots of 156.25 bits each, while 577 μs are available for the transmission of 156.25 bits. In each slot are transmitted, on the other hand, the 114 data bits in two blocks for the user data signal, on the one hand, and 44.25 bits for a protective area, on the other. The physical 124 channels determined by frequencies are thus divided into eight further time-staggered channels by the TDMA method. From these channels some are used as Traffic Channels (TCH) for carrying out the actual user data transport and others are used as Control Channels (DCCH, CCCH, DCCH) for control inside the system, such as for example connection set up or disconnection, handover etc.

This frame structure, however, forms an upper boundary for the data transmission rate. The data transmission rate does allow to be increased by channel coding, convolutional coding, or interleaving, it is true, but certain limits are posed for the increase of the data rate that can be reached in this manner. But this can be regarded as highly problematic due to the ever further increasing amount of data.

Thus the present invention at least faces the problem of providing a possibility that allows to increase the data transmission rate between a base station and a mobile station in a mobile radio system such as for example in a GSM system.

This technical problem is solved by a completely new method of increasing the data transmission rate in a mobile radio system comprising at least one base station and a mobile station, in which the data to be transmitted between the at least one base station and the mobile station are transmitted in combined fashion over a first frequency channel and at least over a second frequency channel.

If the data to be transmitted can be transmitted not only over a single frequency channel, as is known from the state of the art, but in combined fashion over at least two frequency channels, the data transmission rate can be increased considerably. If in this method the multipath and interleaving problem as well as the channel availability and other problems inherent in the system should be taken into account, it is possible with the proposed method to reach an increase of the data transmission rate by about 60 to 80% compared to current class 12 or 14 device generations. So doing the data transmission rates that can be achieved in this way are even higher than in a comparable UTRA-FDD system (UMTS Terrestrial Radio Access FFD system).

According to the invention the data to be transmitted with this method are thus transmitted over at least two frequency channels, it becoming necessary for all the method runs that are normally necessary for the data transmission in one frequency channel, now to be used in the at least two frequency channels for the data. For example, the channel coding or the interleaving should be applied to the data to be transmitted in the two frequency channels.

As already defined above, it is possible with this method to increase the data transmission rate compared to known methods by the factor of 1.6 to 1.8. The greatest advantage of the method comprises that with the method the transmission times for a certain data volume can be minimized. This reduction of the transmission time accordingly diminishes the charges to be paid to the mobile phone provider for the transmission of this data volume. A further advantage of the present invention is that the channel availability in the respective system is improved as a result of the data transmission times shortened by the method according to the invention.

A further preferred embodiment of the method as claimed in claim 1 has the characteristic features of claim 2. According to this the data volume to be transmitted is combined to data packets, for example to so-called bursts and transmitted over at least two frequency channels. Since these data packets are received unclocked by the receiver because of the combined data transmission over at least two frequency channels, the data packets each receive an address coding value before they are transmitted, In this manner the data packets can again be transformed back into their initial format by the receiver in a relatively simple way, that is to say, a reconstruction of the data structure to its format prior to the data transmission is thus made possible.

The method as claimed in claim 1 proves to be particularly advantageous by the embodiment according to the invention as claimed in claim 3. The great advantage is then that the method according to the invention as claimed in claim 1 can especially be used in the most commonly used mobile phone system.

Further advantageous embodiments of the method as claimed in claim 1 are described in claims 4 and 5 according to which the two frequency channels that are used for the data transmission are the 900 MHz and the 1800 MHz band or the 450 MHz and the 1900 MHz band, and the transmission takes place simultaneously over the two frequency channels. This proves to be particularly advantageous because they are the most frequently used frequency channels that are used in Germany for example by D1, D2-Vodafone, E-Plus and Viag Intercom. As a result of respective mutual agreements of the providers it is thus possible to jointly use a frequency channel from another network provider or instruct the provider to transmit the respective data.

The invention further relates to a mobile radio system having the characteristic features of claim 6. The mobile radio system is suitable in that the data transmission between the base stations and the mobile stations does not take place in only one frequency channel, but that for the data transmission a plurality of frequency channels can be fallen back on.

The great advantage of such a mobile radio system as against customary systems is the fact that as a result of the data transmission taking place over at least two frequency channels the data transmission rate per unit of time can be increased considerably, so that for a certain data volume there is a shorter data transmission time. A further advantage is the fact that when part of the data are transmitted over a strange frequency channel of another network provider, the channel availability of the user's own network is improved.

The mobile radio system according to the invention furthermore excels in that the data transmission is made more secure. As the data are transmitted over two frequency channels, a third party that wishes to listen in on this data transmission is to provide access to both channels, which is an additional hurdle.

Furthermore, the present invention relates to a mobile station as claimed in claim 7, which is arranged for carrying out the method as claimed in claim 1, or for being included in the mobile radio system as claimed in claim 6. The present invention also relates to a base station as claimed in claim 8 for carrying out the method as claimed in claim 1. For this purpose the base station is capable of transmitting and receiving simultaneously in a plurality of frequency channels. Also the mobile station is arranged for simultaneously receiving data from various frequency channels or send them on various frequency channels. In the framework of the present invention in essence the receiving operation over two frequency channels is of interest, but also the sending operation can be effected over two or more bands.

The invention further relates to a computer program as claimed in claim 9 with the [sic] for controlling a mobile radio system to increase the data transmission rate in the mobile radio system.

Thus the invention is a combination of various receiving paths on 900 MHz and at the same time on 1800 MHz or 1900 MHz to increase the data rates in a mobile radio system such as the GSM system.

For better understanding and explanation these aspects and further aspects of the present invention will be described in the following in more detail while reference is made to the appended drawings, in which:

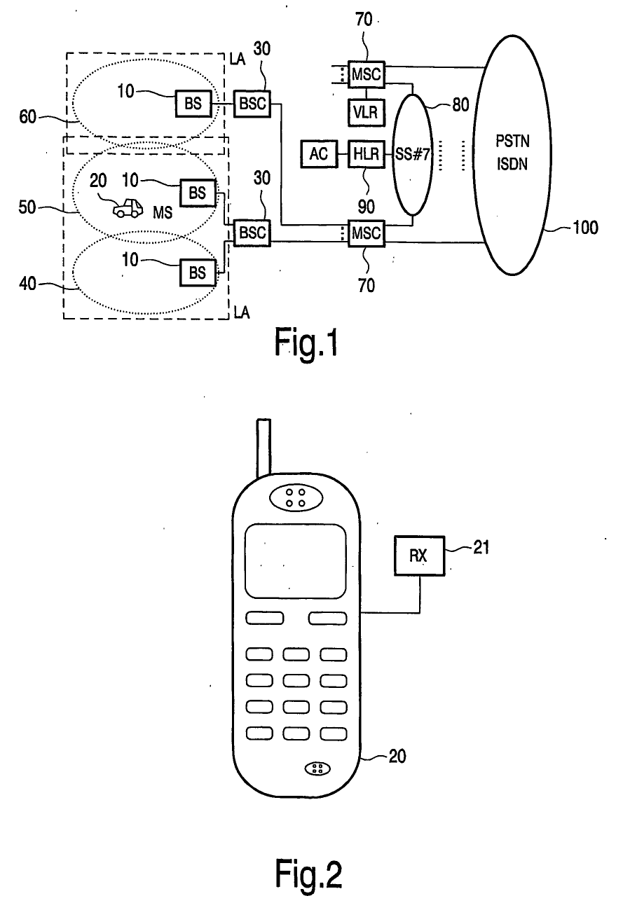

FIG. 1 shows a GSM network infrastructure;

FIG. 2 diagrammatically shows a mobile station for receiving the data transmitted by means of the method according to the invention;

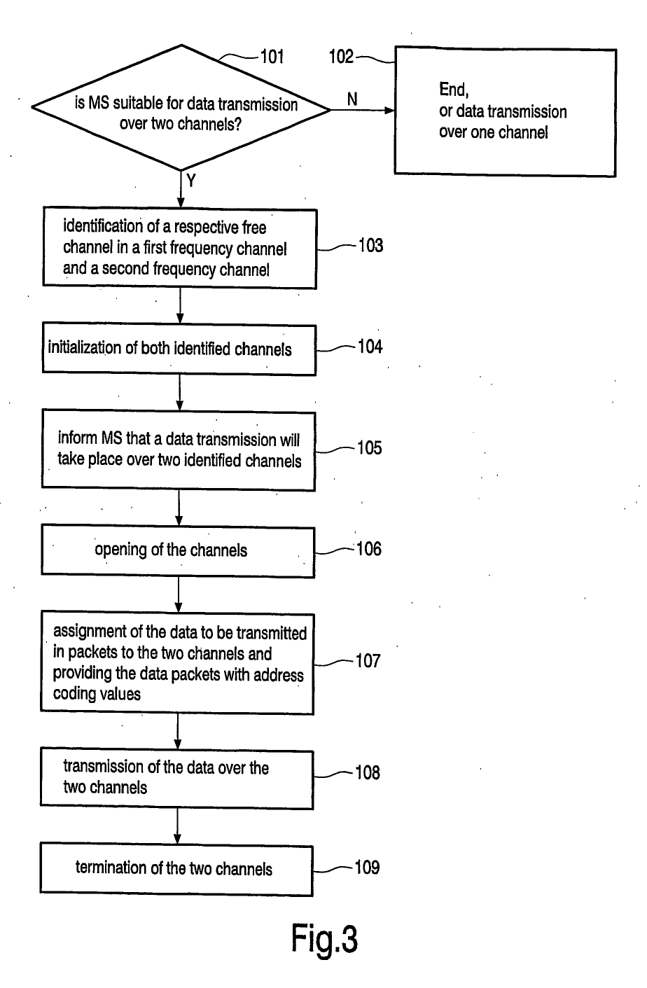

FIG. 3 shows a flow chart of the method according to the invention;

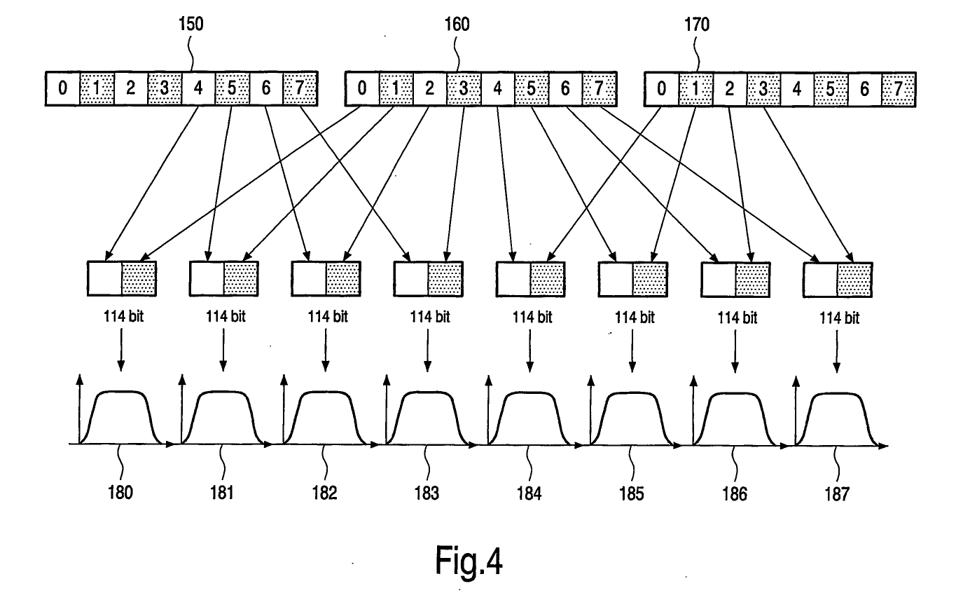

FIG. 4 diagrammatically shows the principle of interleaving for speech data while address coding values are used;

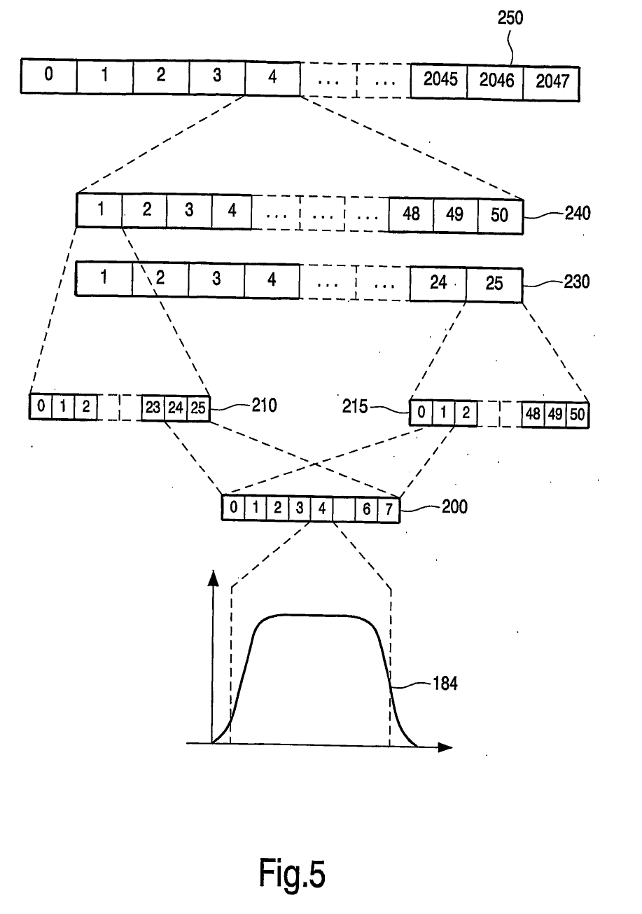

FIG. 5 shows a hierarchical structure and the composition of a hyperframe made of a plurality of TDMA frames;

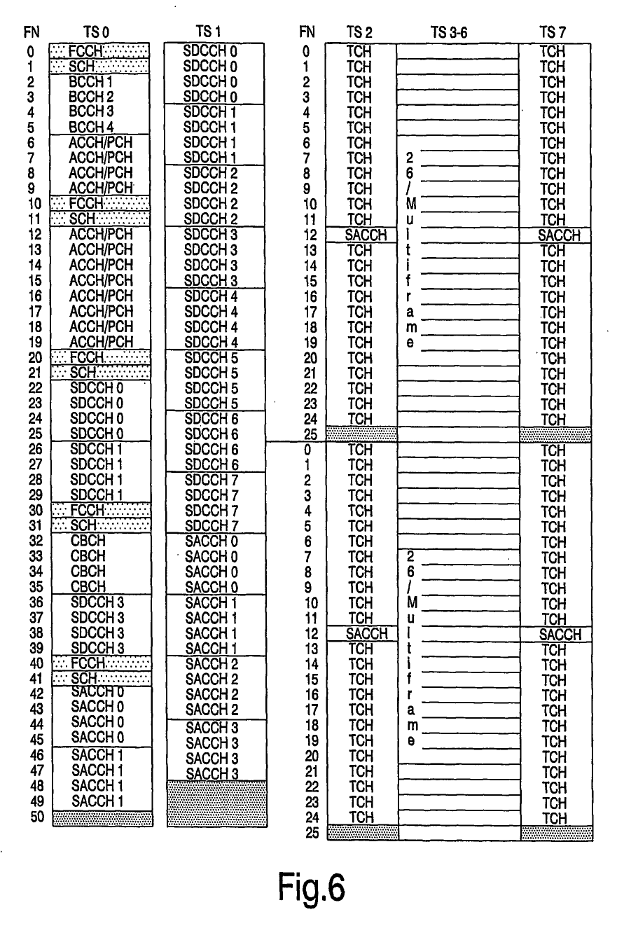

FIG. 6 shows by way of example a respective full-rate downlink channel configuration;

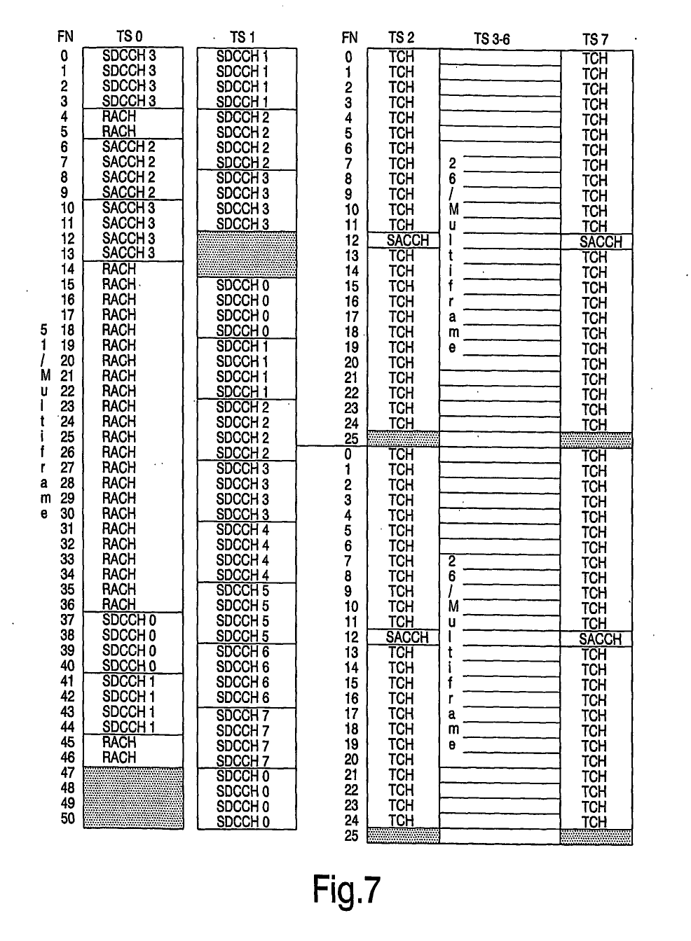

FIG. 7 shows the uplink configuration corresponding to FIG. 6; and

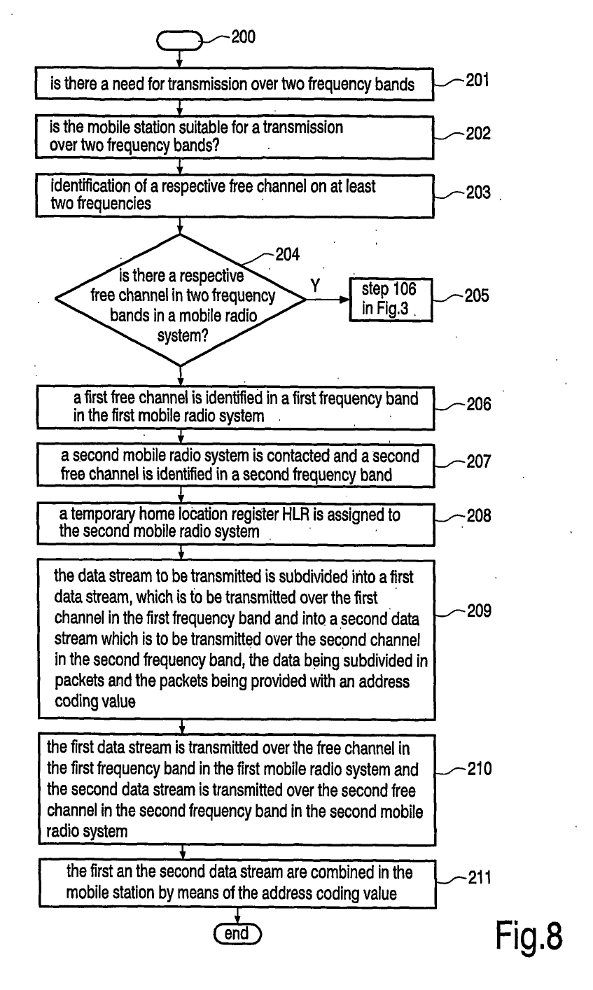

FIG. 8 shows an example of a data transmission over two mobile radio systems.

In all Figures like arrangements have been featured by like reference characters.

FIG. 1 shows a GSM network infrastructure as this can be found in mobile radio systems nowadays. The lower network level here consists of the base stations 10(BS) forming a respective cell, a plurality of which stations are connected to a base station controller 30 (BSC). The two together form a respective base station subsystem (BSS). Such a system supplies one or more cells 40, 50, 60 in which a mobile station 20 (MS) moves around without a location update in the HLR (Home Location Register) 90 being necessary. Such an area (BSS) is also called a Location Area (LA). Each base station (BS) 10 is identified by an identification code of the network or of a mobile station (MS) 20. A plurality of base stations (BS) 10 are customarily combined to clusters which have a size of 7 or 9 cells in the GSM system. A plurality of Base Station Controllers (BSC) 30 are together connected to a Mobile Switching Center (MSC) 70. They are interconnected via an SS#7 network 80. To make a communication possible with the fixed local area network 100, the mobile switching centers (MSC) 70 are coupled with the fixed local area network 100 via gateways.

For receiving data from the fixed local network 100 for example with the mobile station (MS) 20 which is located in cell 50, these data are transmitted from the fixed local area network 100 via the mobile switching center (MSC) 70 and the base station controller (BSC) 30 by means of the base station (BS) 10 via radio signals sent to the mobile station (MS) 20. Depending on what mobile radio system it is, these radio signals have a certain frequency or are situated in a certain bandwidth range. For example, the mobile radio providers D1 and D2-Vodafon transmit in a frequency range around 900 MHz, as against which E-plus and VIAG-intercom transmit and receive in the bandwidth range of 1800 MHz.

Contrary to this data transmission over only one frequency channel, the present invention now provides to accelerate the data transmission in such a way that the data transmission between base station (BS) 10 and mobile station (MS) 20 does not take place over only one frequency channel but at least over two channels in different frequency channels. There is particularly provided to split up the data transmission into the 900 MHz band and the 1800 MHz band to transmit the data combined over these two bands from the base station (BS) 10 to the mobile station (MS) 20. It may also happen that part of the data is transmitted to the mobile station over the 900 MHz band via one base station and the other part of the data over for example the 1800 MHz band via another base station. Alternatively it is possible for the data transmission to take place over the 900 MHz band in a radio cell and the data transmission over the 1800 MHz band in another radio cell. This may mean that for the data transmission of a data volume for example the services of other network providers are taken into account in that part of the data transmission is effected via another network provider. Thus as a system precondition it is obvious that between the individual network providers national and international roaming is to be possible.

To make such a data transmission rate possible over at least two frequency channels, the mobile station (MS) 20 is to be arranged such as regards software and hardware so that data can be received simultaneously over two different bands. Also the radio frequency (RF), the software (SF) and the firmware (FW) of the system in the receive mode is to have sufficiently fast access and change-over speeds to make a reliable real-time combination possible upon receipt of the data packets. Furthermore, both the IMSI (International Mobile Subscriber Number) and the TMSI (Temporary Mobile Subscriber Number) of the mobile station (MS) 20 as well as the respective entry in the HLR (Home Location Register) and in the VLR (Visitor Location Register) of the network provider over which the combined data transmission rate according to the invention should take place, should match, in order for the mobile station (MS) 20 to be located and assigned a certain mobile radio user, irrespective of its whereabouts.

In addition, the authorization of the mobile station (MS) 20 must be effected with the aid of the authorization algorithm A3 in the two systems with the same identical Ki-value, just as the Kc-value in both systems which is calculated with the key generation algorithm A8 should be identical for the speech encoding. Since there is a worldwide unique Ki-value for each mobile station (MS) 20 and thus also a worldwide unique Kc-value which can be derived from the Ki-value, as is known, this system requirement, however, is always satisfied.

FIG. 2 shows such a mobile station (MS) 20 which as a rule is a dual-band or triband mobile phone known from the state of the art. To nevertheless be able to receive the data transmitted over two frequency channels, the mobile station (MS) 20 includes a specific receiving unit 21 which is arranged so that it can simultaneously receive the data from the two frequency channels. The mobile station 20, however, may also be a portable laptop computer with a receiving unit or a handheld computer also with such a receiving unit.

FIG. 3 shows a flow chart of the method according to the invention for increasing the data transmission rate between a mobile station (MS) 20 and a base station (BS) 10 in a mobile radio system. The method describes the individual steps which a computer program is to execute to make the data transmission possible on at least two frequency channels between a base station (BS) 10 and a mobile station (MS) 20. This computer program is for example stored in one of the units BS, BSC or MSC of the GSM network infrastructure and is executed from there. The computer program—with respectively adapted method steps—may, however, also be stored in a storage unit of the mobile station.

The method according to the invention comprises for the receive mode the following steps of:
a) Enquiring with MS whether MS is suitable for data transmission over at least two channels;
b) If it is, identifying each time one free channel in the 900 MHz and in the 1800 MHz band;
c) Initializing the two identified channels;
d) Announcing to MS over what channels the data transmission will take place;
e) Opening of the channels;
f) Assigning the data packet by packet to the two channels and giving the data packets a respective address coding value;
g) Transmitting the data packets;
h) Terminating the channels.

Obviously it is also possible to implement the method in a similar, slightly modified manner also for the transmission mode.

If in the method step a) it is found that the mobile station (MS) is unsuitable for a data transmission over two channels, the method is terminated at this point and a data transmission takes place in known manner over only one channel or one frequency channel, respectively.

In the following the individual method steps will be described more elaborately. In a first method step 101 the computer system stored in the base station controller 30 establishes whether the mobile station (MS) 20 to which a data transmission is to take place, has the suitability of receiving data over two frequency channels, thus has a receiving unit 21 as shown in FIG. 2. If the program establishes in step 101 that the mobile station (MS) 20 does not have this suitability, the method ends in step 102 and a data transmission takes place in conventional form over one frequency channel.

If, however, the computer program establishes in step 101 that the mobile station (MS) 20 has the ability to receive the data combined over two frequency channels the computer program instructs in a next method step 103 an identification unit in the base station controller 130 to identify a respective free channel in a first and in a second frequency channel. The first frequency channel is preferably situated near 900 MHz and the second frequency channel near 800 MHz. On the other hand, the second frequency channel in North America is preferably situated near 1900 MHz.

After two free channels have been identified by the base station controller 30, the computer program instructs the base station controller 30 in a next method step 104 to initialize these two channels and to inform the mobile station 20 in a further method step 105 that a data transmission will be effected over the channels that have just been identified and initialized. In a further step 106 the channels that have just been identified and initialized are opened for a transmission of the data volume to be transmitted.

The moment the channels have been opened, in step 107 can be commenced to assign the data to be transmitted to the two channels. This assignment may be effected in accordance with a certain assignment instruction or in accordance with certain data criteria. Another type of assignment comprises carrying through a serial data transmission in which each data block is transmitted over the channel that is not occupied just then.

In principle, however, the data to be transmitted are assigned in packets to the at least two channels that have meanwhile been opened. Since the data packets are transmitted over the two channels, it is necessary for the data packets to be provided with an address coding value prior to the transmission, which value at a later stage, for example upon receipt, makes it possible to transform the data packets back into their initial format.

Once the data volume has been packed into data packets in this way, has been provided with address coding values and has been transmitted in step 108, finally, in step 109, the two channels are closed again and the transmission is terminated.

FIG. 4 shows how the data to be transmitted are provided with an address coding value during for example an interleaving operation. In the upper level of FIG. 4 three data blocks 150, 160 and 170 are represented, which may possibly already have been coded in a previous method step implementing a known channel coding method. The data blocks coded in this way are transformed in a furter method step into bursts 180 to 187 represented here in the second level, and each provided with an address coding value. Each burst data packet is formed by two data sequences which, however, originate from different data blocks 150, 160 and 170 coded by means of interleaving. Each burst then has a usable data volume of 114 bits, which again is exactly the usable data length of a time slot, so that one transmission time slot can be assigned to each burst. The burst formating represented in FIG. 4 with an assignment of an address coding value is then basically to be carried out already prior to the assignment of the data to the respective frequency channels over which they are to be transmitted.

FIG. 5 shows the frame structure starting from the burst 184 of FIG. 4, which structure is used for the combined data transmission in the two frequency channels. The smallest unit is here, as already discussed with reference to FIG. 4, the time slot or burst 184 respectively, which has a data length of 114 bits, for the transmission of which 577 μs are available. The burst 184 here represents the fourth time slot of the TDMA frame 200 in enlarged form in dependence on time and intensity. In the hierarchical frame structure present here, eight of these time slot's 184 (thus the bursts 180 to 187 in FIG. 4) are combined to a TDMA frame 200, while each TDMA frame 200 has a period duration of 4.615 ms. The eight time slots of the TDMA frame 200 are riot all used for the transmission of user data, however, but only the time slots 2 to 7 are used as traffic channels (TCH) for the actual data transport. The time slots 0 and 1, on the other hand, are used as control channels (CCH) for the internal system control, such as for example connection set up and disconnection, handover etc. An illustrative downlink or uplink channel configuration can be learnt from the FIGS. 6 and 7.

If in FIG. 5 the hierarchical frame structure is followed upwards in FIG. 5, again 26 TDMA frames are combined to a so-called 26-multiframe 210 or 51 TDMA frames to a so-called 51-multiframe 215. The distinction between the frame structure 210 and the multiframe structure 215 is then realized in that preferably the multiframe 210 is used for the transmission of user data, whereas preferably the multiframe structure 215 is used for the transmission of signal data.

If the hierarchical structure is followed once more for another level upwards, 51 of the 26-multiframes 210 and 26 of the 51-multiframes 215 can be combined to a respective superframe of a length of 6.12 seconds. The upper level of this hierarchical frame structure forms the so-called hyperframe 250 in which 2048 (2″) superframes are combined to one unit.

The hierarchical frame structure described in FIG. 5 is used with the method according to the invention for the data transmission in the two frequency channels or in the two channels, respectively. Naturally, it is also possible to arrange the data in another, structured way.

FIGS. 6 and 7 show, as already discussed above, an illustrative channel configuration for the downlink or uplink transmission operation. Both in FIG. 6 and in FIG. 7 can be detected that only the time slots 2 to 7 are used as traffic channels (TCH). The time slots 0 and 1, on the other hand, are only used as control channels (CCH). Here too can be detected that the control channels (TS0 and TS1) are formed by 51-TDMA frames each, whereas the traffic channels are formed by 2×26 TDMA frames.

FIG. 8 shows an example of an application of the present invention in that a data transmission is effected combined over a first frequency channel in a first mobile radio system and a second frequency channel in a second mobile radio system. After the initialization in step 200, in step 201 it is established whether there is a need for transmission over two frequency channels. The data volume to be transmitted is investigated for this purpose and, if the data volume to be transmitted exceeds an adjustable threshold value, a requirement is made to transmit data combined over two different frequency channels. Then the processing proceeds to step 202 in which there is a query whether the mobile station to which the data are to be transmitted is suitable for receiving data combined over two frequency channels. If the mobile station is suitable for receiving data over two different frequency channels, the processing proceeds to step 203, in which each time one free channel is identified in the two frequency channels, for example, in the 900 MHz and the 1800 MHz band.

In the following step 204 a query is carried out whether two found free channels in the two different frequency channels belong to a mobile radio system or not. If it were possible to identify a respective free channel in two different frequency channels in a mobile radio system, the processing is continued in step 205, from where the processing is proceeded with in accordance with step 106 and step 109 in FIG. 3.

If the query in step 204 is negative, i.e. if there are no two free channels in two different frequency channels in the one mobile radio system to which the mobile station is assigned, the processing is proceeded with step 206.

In step 206 a first free channel is identified in a first frequency channel in the mobile radio system to which the mobile station is assigned. This mobile radio system will hereafter be referred to as the first mobile radio system. Then the processing is proceeded with in step 207 in which a second mobile radio system is contacted and a second free channel is identified in a second frequency channel in this second mobile radio system. Then the processing is continued in step 208 in which a temporary home location register (HLR) in the second mobile radio system is assigned to the mobile station, so that in the second mobile radio system a data transmission can be carried out in known fashion over a second free channel on the second frequency channel. Then the processing goes to step 209 in which the data stream to be transmitted to the mobile station is subdivided into a first data stream that is to be transmitted over the first channel in the first frequency, channel in the first mobile radio system, and a second data stream that is to be transmitted over the second free channel in the second frequency channel in the second mobile radio system. This subdivision is carried out in analogy with the subdivision that has been described with reference to step 107 in FIG. 3. Worded differently, a resorting takes place of data packets as well as an addition of address coding values to the data packets. This is effected, for example, in the first mobile radio system. For this purpose a data splitter device can be provided at a suitable place in the first mobile radio system. Then the processing goes on to step 210 in which the first data stream is transmitted to the mobile station over the first free channel in the first frequency channel in the first mobile radio system. Also in step 210 the second data stream is transmitted over the second free channel in the second frequency channel in the second mobile radio system. The transmission of the first data stream in the first mobile radio system to the mobile station takes place in known fashion. Similarly, the transmission of the second data stream in the second mobile radio system to the mobile station takes place in known fashion. Then the processing continues to step 211 in which the first and the second data stream that have been received in the mobile station are combined in the proper way by means of the address coding value. Then the processing is proceeded with in step 212 where the processing ends.

Since for the mobile station in the second mobile radio system more or less a transmission of the second data stream is implemented as a regular subscriber to the second mobile radio system, a channel coding and an interleaving as well as the whole transmission of the data in the second mobile radio system can be carried out in known fashion. Also a handover can be carried out in known fashion. This also applies to the first mobile radio system.

Summarizing it may be accordingly be stated that the invention makes a considerable increase of the data transmission rate possible in a mobile radio system to a mobile station by means of a transmission via a combined transmission over at least two frequency channels. Since the data transmission is carried out in a manner known per se with a transmission of data over two different mobile radio systems to a mobile station in each mobile radio system, the whole data transmission and signaling, as this is customary nowadays for example in GSM systems, can be maintained in these systems, so that no substantial changes in the signaling protocols of the infrastructure are necessary.

1. A method of increasing the data transmission rate between at least one base station and one mobile station in a mobile radio system, in which the data to be transmitted between the at least one base station and the mobile station are transmitted in combined fashion over a first frequency channel and at least a second frequency channel.

2. A method as claimed in claim 1, characterized in that the data to be transmitted are transmitted over the at least two frequency channels in packets provided with an address coding value, as a result of which the data can be combined again at some later time.

3. A method as claimed in claim 1, characterized in that the mobile radio system is a GSM, a PCS or a PCN system.

4. A method as claimed in claim 1, characterized in that the data transmission takes place simultaneously over the first and the second frequency channel.

5. A method as claimed in claim 1, characterized in that the first frequency channel is a 900 MHz frequency channel and the second frequency channel is selected from a group which consists of the 1800 MHz frequency channel and the 1900 MHz frequency channel.

6. A mobile radio system for mobile communication comprising at least one base station and one mobile station in which the data transmission takes place in combined fashion to increase the data transmission rate between at least one base station and the mobile station over a first frequency channel and at least a second frequency channel.

7. A mobile station for use in a mobile radio system for mobile communication comprising at least one base station of the GSM system, comprising a receiving unit for receiving data from the at least one base station in combined fashion over a first frequency channel and at least a second frequency channel.

8. A base station for use in a mobile radio system for mobile communication with a mobile station, in which the base station is arranged for transmitting data to the mobile station, the transmission of data to the mobile station being carried out in combined fashion over a first frequency channel and a second frequency channel.

9. A computer program for controlling a data transmission between at least one base station and a mobile station in mobile radio systems to increase the data transmission rate, the computer program containing indications for the at least one base station and the mobile station so that the data to be transmitted between the at least one base station and the mobile station are transmitted over a first frequency channel and at least over a second frequency channel.
